(19) United States
(12) Patent Application Publication
(10) Pub. No.: US 2024/0302291 A1
(43) Pub. Date: Sep. 12, 2024

(54) Waveguide Defect Control

(71) Applicant: Envisics Ltd, Milton Keynes (GB)

(72) Inventors: Alexander Cole, Milton Keynes (GB); Timothy Smeeton, Milton Keynes (GB)

(21) Appl. No.: 18/435,533

(22) Filed: Feb. 7, 2024

(30) Foreign Application Priority Data
Mar. 10, 2023 (GB) 2303529.8

(51) Int. Cl. G01N 21/954; G01N 21/59; G01N 21/88

(52) U.S. Cl. CPC G01N 21/954; G01N 21/59; G01N 21/8806

(57) ABSTRACT

A light engine for detecting a defect is provided. The light engine comprises a waveguide. The waveguide comprises a first surface that is partially transmissive-reflective, and a second surface opposite to the first surface. The waveguide is configured to receive, on an input port, an input wavefront and provide waveguiding of the input wavefront by internal reflection between the first and second surfaces thereby replicating the input wavefront along a replication direction. The light engine further comprises a light detector positioned to measure an intensity of a residual portion of the holographic wavefront after waveguiding is provided by the waveguide.

### CROSS-REFERENCE TO RELATED APPLICATIONS

This application claims priority under 35 U.S.C. § 119 to UK Patent Application GB 2303529.8 titled “Waveguide Defect Control,” filed on Mar. 10, 2023, and currently pending. The entire contents of GB 2303529.8 are incorporated by reference herein for all purposes.

### FIELD

The present disclosure relates to an arrangement for detecting faults in a light engine. More specifically, the present disclosure relates to a light engine comprising a light sensor optically coupled to a waveguide of the light engine. Some embodiments relate to a holographic projector, picture generating unit or head-up display.

### INTRODUCTION

Light scattered from an object contains both amplitude and phase information. This amplitude and phase information can be captured on, for example, a photosensitive plate by well-known interference techniques to form a holographic recording, or “hologram”, comprising interference fringes. The hologram may be reconstructed by illumination with suitable light to form a two-dimensional or three-dimensional holographic reconstruction, or replay image, representative of the original object.

Computer-generated holography may numerically simulate the interference process. A computer-generated hologram may be calculated by a technique based on a mathematical transformation such as a Fresnel or Fourier transform. These types of holograms may be referred to as Fresnel/Fourier transform holograms or simply Fresnel/Fourier holograms. A Fourier hologram may be considered a Fourier domain/plane representation of the object or a frequency domain/plane representation of the object. A computer-generated hologram may also be calculated by coherent ray tracing or a point cloud technique, for example.

A computer-generated hologram may be encoded on a spatial light modulator arranged to modulate the amplitude and/or phase of incident light. Light modulation may be achieved using electrically-addressable liquid crystals, optically-addressable liquid crystals or micro-mirrors, for example.

A spatial light modulator typically comprises a plurality of individually-addressable pixels which may also be referred to as cells or elements. The light modulation scheme may be binary, multilevel or continuous. Alternatively, the device may be continuous (i.e. is not comprised of pixels) and light modulation may therefore be continuous across the device. The spatial light modulator may be reflective meaning that modulated light is output in reflection. The spatial light modulator may equally be transmissive meaning that modulated light is output in transmission.

A holographic projector may be provided using the system described herein. Such projectors have found application in head-up displays, “HUD”.

### SUMMARY

Generally, there is provided a light engine arranged to form an image visible from a viewing window. The light engine may be part of a holographic projector which, in turn, may be a part of a head-up display (HUD). There is a need in light engines, for example in a light engine of a head-up display, to confirm that a consistent/expected amount of light is output by the light engine. A fault or defect in the light engine may result in the intensity of the output light being lower/higher than expected. This may adversely affect the quality of the image seen from the viewing window.

Some light engines/holographic projectors comprise a light source and a display device arranged to display a hologram of the picture. The light source may be arranged to illuminate the display device such that light is spatially modulated in accordance with the hologram. An optical component (such as a lens) is arranged to form a holographic reconstruction of the picture. A convenient way of monitoring the amount of light passing through such a light engine is to measure an intensity of the holographic reconstruction, for example by measuring the intensity of a control spot of the holographic reconstruction having a well-defined/expected intensity. If the measured intensity of the control spot is different to the expected intensity, then this may be indicative of a fault in one of the optical components upstream of the holographic reconstruction. For example, this may be indicative of a fault with the laser or the display device.

The inventors have recognised that defects in the light engine downstream of the holographic reconstruction may not be detected by the above arrangement. Some light engines comprise a waveguide comprising a pair of opposing (optionally, parallel) surfaces. The waveguide is typically downstream of said holographic reconstruction. A first surface of the pair of surfaces of the waveguide is typically partially transmissive-reflective. The waveguide is arranged to provide waveguiding of an input wavefront by internal reflection between the pair of surfaces; wherein at least a portion of a first surface of the pair of surfaces forms an output port that is partially transmissive-reflective such that the wavefront is divided at each reflection therefrom to generate a plurality of replicas of the input wavefront. As the waveguide is downstream of the holographic reconstruction, defects in the waveguide may not be detected by measuring the intensity of the holographic reconstruction. Such defects may cause undesired intensity variation in the waveguide. For example, a defect in the waveguide may result in scattering of the input wavefront at one or more locations of the waveguide. This may change the proportion of the light that is reflected and/or transmitted by the first and/or second surface of the waveguide. In particular, this may result in one or more of the replicas having a lower or higher intensity than expected and may also result in replicas downstream of the fault also having a lower or higher intensity than expected.

An intensity measurement made upstream of the waveguide cannot be used to determine a defect of the waveguide. However, measuring the intensity of replicas output by the waveguide is not suitable for waveguide fault detection. For example, replicas that are measured will inevitably be at least partially blocked by the detection apparatus which will adversely affect the light received at an eye-box. This may be a problem because, unlike at the holographic reconstruction plane which is a reconstruction of the image of the hologram, the replicas output by the waveguide are replicas of the input/holographic wavefront, which is spatially modulated light in accordance with a hologram (i.e. in the hologram domain rather than the image domain). Thus, any control spots in the target image/holographic reconstruction will not be present as individual control spots in the hologram domain of the replicas (i.e. in the holographic wavefront).

In general terms, the inventors have found that defects of the waveguide can advantageously be detected by positioning a light detector to make at least one measurement of the intensity of one or more residual holographic wavefronts after waveguiding is provided by the waveguide. This advantageously allows for defects to be detected (for example, when the intensity of the (residual) holographic wavefront after waveguiding is higher or lower than expected). Some embodiments advantageously also provide an indication of the location of the defect of the waveguide.

In more detail, the holographic wavefront may be internally reflected between the first and second surfaces of the waveguide, with replicas of the holographic wavefront being generated at the partially transmissive-reflective first surface. Eventually, a portion of the holographic wavefront will have propagated out of the waveguide. This portion may be referred to as a residual portion of the wavefront and will not be emitted out of the partially transmissive-reflective first surface. The waveguide will typically be arranged such that, by this point, most of the intensity of the input wavefront will have been redirected to each of the holographic wavefront replicas. However, invariably, at least a small residual portion of the holographic wavefront reaches the end of the waveguide. Since no further waveguiding occurs, the residual portion of the holographic wavefront is transmitted out of the waveguide in the propagation/replication direction through the waveguide, such as through an end surface or edge of a bulk optic waveguide. Normally this residual portion of the light of the input wavefront would simply be discarded. However, the inventors have recognised that the intensity of (the residual portion of) the holographic wavefront after the waveguide contains useful information. If this intensity is different than expected, then this may be indicative of a defect.

Furthermore, in some examples, the waveguide may be arranged to receive a plurality (e.g. 1D array extending in a first direction) of holographic wavefronts and waveguide each of those plurality of holographic wavefronts (e.g. in a second direction perpendicular to the first) to generate a substantially 2D array of replicas of the holographic wavefront at a (primary) output of the waveguide. In such cases, the intensity of each of plurality of holographic wavefronts can be directly or indirectly measured after waveguiding—e.g. a residual portion each holographic wavefront may be measured at e.g. a secondary output of the waveguide. A permanently or temporally higher or lower than expected intensity in one or more of the plurality of input wavefronts may be used to determine a defect in the waveguide. For example, a change in the intensity of the residual portion of one of the plurality of holographic wavefronts may be indicative of a occurrence of a defect of the waveguide or even failure of a component of the holographic system. Also, because each of the holographic wavefronts may be associated with a different portion or section of the waveguide, the particular holographic wavefront having the unexpected intensity, or change in intensity, may be used to locate the defect to that portion of the waveguide.

Thus, the inventors have provided a light engine and an associated method in which a defect (such as a defect in a waveguide) may be detected and, in at least some embodiments, in which the location of a defect be identified (for example, the location of a defect within a waveguide).

Aspects of the present disclosure are defined in the appended independent claims.

In an aspect, there is provided a light engine for detecting a defect such as a waveguide defect. The light engine comprises a waveguide comprising a first surface that is partially transmissive-reflective, and a second surface positioned opposite to the first surface. The fault that the light engine is arranged to detect may be a defect with the waveguide such as damage or degradation of the waveguide, such as damage or degradation of an optical coating on the waveguide, for example on a surface of the waveguide. A surface being partially transmissive-reflective means that light incident on that surface will have a portion that is reflected and a portion that is transmitted. The waveguide is configured to receive, on an input port (which may be on the first surface), an input wavefront, and provide waveguiding of the input wavefront by internal reflection between the first and second surfaces thereby replicating the input wavefront along a replication direction. The light engine further comprises a light sensor/detector. The light detector is arranged/positioned to measure an intensity of a residual portion of the holographic wavefront after waveguiding is provided by the waveguide.

As used herein, the “residual portion” of the holographic wavefront is a portion of the holographic wavefront that exits the waveguide along the replication direction. The input wavefront may be replicated at the partially transmissive-reflective surface of the waveguide. The residual portion may be a portion of the holographic wavefront which is not replicated at or transmitted by the partially transmissive-reflective surface of the waveguide. In other words, the light engine may be arranged such the residual portion of the holographic wavefront is the remaining portion of the holographic wavefront after the holographic wavefront has travelled through the waveguide along the replication direction. In some embodiments, the waveguide comprises an end surface positioned between the first and second surface. The end surface may connect the first and second surfaces. The end surface may be orthogonal to one or both of the first and second surfaces. The waveguide/light engine may be arranged such that the residual portion of the holographic wavefront propagates through the end surface of the waveguide (escapes the waveguide through the end surface). In some embodiments, the light sensor/detector is optically coupled to the end surface. Thus, the light detector may be arranged to receive the residual portion after the residual portion has propagated from the end surface. The light sensor/detector may be positioned between planes defined by the first and second surfaces. The light receiving surface of the light sensor/detector may be arranged in a plane extending between the planes of the first and second surfaces, such as a plane substantially orthogonal to the first and second surfaces. In this way, the residual portion of the wavefront, which is propagating generally in the replication direction (i.e. with light rays in a direction having a component in the replication direction), is incident on the light receiving surface of the light sensor/detector. The light sensor may comprise an array of sensors. The array of sensors may be positioned equidistantly from each other. Each of the array of sensors may be a photodiode. Advantageously, defects in the waveguide can be determined. The defects can indicate if there is any damage or degradation in the waveguide/an optical coating of the waveguide.

The input port may be an in-coupling port. The first and second surfaces may be a pair of opposing parallel surfaces. The second surface may be fully reflective or partially transmissive reflective. The internal reflection of the holographic wavefront may result in the holographic wavefront being divided at each reflection. A replica of the holographic wavefront may be generated at each reflection. At least a portion of the partially transmissive-reflective first surface may form an output port. A plurality of replicas of the holographic wavefront may be transmitted through the output port. The light sensor may be arranged to make a plurality of measurements of light along an edge of the waveguide. The light sensor may be optically coupled to the edge of the waveguide. The edge may be opposite to the input port. The array of sensors may extend in a direction substantially perpendicular to the replication direction. The array of sensors may extend in a direction that is parallel to the edge of the waveguide.

The waveguide may be in the form of a block or slab. The waveguide may comprise an end surface. The edge may be the end surface of the waveguide. The light sensor may be optically coupled to the end surface of the block or slab. In embodiments, a residual portion of the holographic wavefront/s may be emitted from the edge or end surface of waveguide once it has passed beyond the waveguide.

The above-described waveguide may be a first waveguide. The light engine may further comprise a further (second) waveguide comprising a further first surface that is partially transmissive-reflective, and a further second surface positioned opposite to the further first surface. The first waveguide may be downstream of the further (second) waveguide. The first waveguide may be arranged to receive an output from the first waveguide as an input. The further (second) waveguide is configured to receive, on a further input port on the further first surface, a further holographic wavefront, provide waveguiding of the further holographic wavefront by internal reflection between the further first and second surfaces thereby replicating the further holographic wavefront along a further replication direction, where the further replication direction is perpendicular to the replication direction, and output, from the further first surface or the further second surface, the holographic wavefront. The input wavefront may comprise a plurality of replicas of the further holographic wavefront. The further first surface and the further second surface may be parallel to each other. The plurality of replicas of the further holographic wavefronts are transmitted through an output port. The output port may be positioned on either the further first or second surfaces.

The light sensor/detector may be configured to measure the intensity of the residual portion of the holographic wavefront/s after waveguiding is provided by the waveguide by measuring an intensity of a residual portion of the plurality of replicas of the further holographic wavefront/s after waveguiding is provided by the waveguide.

The further waveguide may be a waveguide having an elongated shape. The elongated shape has a length along a longitudinal direction of the further waveguide. The length may be greater than a width and a thickness of the further waveguide. Each of the width and thickness is a respective dimension of the further waveguide along a direction that is perpendicular to the longitudinal direction. The further waveguide may be configured to produce replicas of a wavefront along its length, i.e. its longitudinal direction.

The waveguide may have a planar shape. The planar shape has a length and a width that are similar in size to each other. The length and width are along directions that define the plane of the planar shape. The thickness of the waveguide may be smaller than each of the length and width. Each of the length, width, and thickness may be perpendicular to each other. The waveguide may be configured to produce replicas of a wavefront along either its length and/or width.

The light engine may further comprise a further light sensor positioned between planes defined by the further first and second surfaces. The further light sensor may be configured to measure a further intensity of a residual portion of the further holographic wavefront after waveguiding is provided by the further waveguide.

The light engine may further comprise a control device comprising at least one aperture arranged to be switchable between a light transmissive state and a light non-transmissive state. The light engine may be arranged such that the holographic wavefront/s passes through the at least one aperture prior to being received at the input port.

The light engine may further comprise a processor communicatively coupled to the light sensor. The processor may be configured to determine a defect based on the measured intensity. For example, the processor may be configured to determine a defect based on a temporal change in the measured intensity. The processor may be arranged to detect a temporal change in at least one of the plurality of measurements of light along the edge of the waveguide and to determine the presence of a defect in the light engine based on a temporal change in the measured property of light.

The processor may be configured to determine a defect based on the measured intensity based on a comparison with a threshold intensity. For example, a defect may be determined when the measured intensity is less than a threshold intensity. In some embodiments, the processor may be configured to determine the defect based on a comparison between the measured intensity and an expected intensity. The expected intensity may correspond to an intensity when there is no defect present along the propagation path of the light being measured. The residual portion may be the portion that exits the waveguide from a third surface or an opening extending between the first surface and the second surface. The intensity may depend on the distance between the particular replica being measured and the input port. The greater the distance, the lower the intensity of the residual portion (explained in more detail below). The expected intensity may also take into account of this decrease in intensity. The decrease in intensity can be calculated for the system based on the light propagation properties of the waveguide and the propagation path of that particular replica.

The processor may be configured to determine the defect based on a comparison between a measured intensity of a residual portion of one of the replicas of the further holographic wavefront and a measured intensity of a residual portion of an adjacent/neighbouring replica of the further holographic wavefront.

The processor may be configured to determine the defect based on whether the at least one aperture is in the light transmissive state or the light non-transmissive state. The expected intensity may take into account of whether the at least one aperture is in the light transmissive state or the light non-transmissive state. For example, if the aperture is in the light non-transmissive state the expected intensity of the replica that is blocked by that aperture would be substantially zero. The processor may be arranged to retrieve a plurality of values for the light based on a current state of one or more of the apertures. The values may be predetermined values. The values may be retrieved from a memory.

Each sensor of the array of sensors (of the light detector) may be positioned to receive a respective replica of the further holographic wavefront. The processor may be further configured to determine a location of the defect based on the array of sensors, for example based on a intensity measurement performed using one or more of the array of sensors. The processor may be configured to determine the location of the defect based on which sensor in the array of sensors detected the fault.

The waveguide may comprise a third surface extending from the first surface to the second surface. The light sensor may be optically coupled to the third surface.

In yet another aspect, there is provided a method for determining a defect in a light engine. The method comprises receiving, on an input port on a first surface of a waveguide, an input wavefront, the first surface being partially transmissive-reflective, providing waveguiding of the input wavefront by internal reflection of the input wavefront between the first surface and a second surface of the waveguide positioned opposite to the first surface, and measuring, by a light sensor, a intensity of a residual portion of the input wavefront after waveguiding has been provided by the waveguide.

The method may further comprise receiving, on a further input port on a further first surface of a further waveguide, a further input wavefront, the further first surface being partially transmissive-reflective, providing waveguiding of the further input wavefront by internal reflection of the further input wavefront between the further first surface and a further second surface of the further waveguide positioned opposite to the further first surface, and outputting, the input wavefront, from the further second surface towards the first surface.

The method may comprise determining, by a processor communicatively coupled to the light sensor, the fault based on the measured intensity. The method may further comprise measuring, by a further light sensor, a further intensity of a residual portion of the further input wavefront after waveguiding is provided by the further waveguide. The determining of the fault may be further based on the measured further intensity of the further input wavefront.

The determining of the fault may comprise comparing the measured intensity with an expected intensity or comparing a measured intensity of a residual portion of one of the replicas of the further input wavefront with a measured intensity of a residual portion of an adjacent/neighbouring replica of the further input wavefront.

The light sensor may comprise an array of sensors, each of which may be positioned to receive a respective replica of the further input wavefront. The method may further comprise determining, by the processor, a location of the fault based on the array of sensors. Advantageously, the exact location of the fault can be determined. This facilitates a faster/more accurate repair of the waveguide. For example, when the exact location of the damage or degradation of the optical coating is known, reapplication of the optical coating on that area can be done much faster and/or more targeted.

In the present disclosure, the term “replica” is merely used to reflect that spatially modulated light is divided such that a complex light field is directed along a plurality of different optical paths. The word “replica” is used to refer to each occurrence or instance of the complex light field after a replication event-such as a partial reflection-transmission by a pupil expander. Each replica travels along a different optical path. Some embodiments of the present disclosure relate to propagation of light that is encoded with a hologram, not an image—i.e., light that is spatially modulated with a hologram of an image, not the image itself. It may therefore be said that a plurality of replicas of the hologram are formed. The person skilled in the art of holography will appreciate that the complex light field associated with propagation of light encoded with a hologram will change with propagation distance. Use herein of the term “replica” is independent of propagation distance and so the two branches or paths of light associated with a replication event are still referred to as “replicas” of each other even if the branches are a different length, such that the complex light field has evolved differently along each path. That is, two complex light fields are still considered “replicas” in accordance with this disclosure even if they are associated with different propagation distances-providing they have arisen from the same replication event or series of replication events.

A “diffracted light field” or “diffractive light field” in accordance with this disclosure is a light field formed by diffraction. A diffracted light field may be formed by illuminating a corresponding diffractive pattern. In accordance with this disclosure, an example of a diffractive pattern is a hologram and an example of a diffracted light field is a holographic light field or a light field forming a holographic reconstruction of an image. The holographic light field forms a (holographic) reconstruction of an image on a replay plane. The holographic light field that propagates from the hologram to the replay plane may be said to comprise light encoded with the hologram or light in the hologram domain. A diffracted light field is characterized by a diffraction angle determined by the smallest feature size of the diffractive structure and the wavelength of the light (of the diffracted light field). In accordance with this disclosure, it may also be said that a “diffracted light field” is a light field that forms a reconstruction on a plane spatially separated from the corresponding diffractive structure. An optical system is disclosed herein for propagating a diffracted light field from a diffractive structure to a viewer. The diffracted light field may form an image.

The term “hologram” is used to refer to the recording which contains amplitude information or phase information, or some combination thereof, regarding the object. The term “holographic reconstruction” is used to refer to the optical reconstruction of the object which is formed by illuminating the hologram. The system disclosed herein is described as a “holographic projector” because the holographic reconstruction is a real image and spatially-separated from the hologram. The term “replay field” is used to refer to the 2D area within which the holographic reconstruction is formed and fully focused. If the hologram is displayed on a spatial light modulator comprising pixels, the replay field will be repeated in the form of a plurality diffracted orders wherein each diffracted order is a replica of the zeroth-order replay field. The zeroth-order replay field generally corresponds to the preferred or primary replay field because it is the brightest replay field. Unless explicitly stated otherwise, the term “replay field” should be taken as referring to the zeroth-order replay field. The term “replay plane” is used to refer to the plane in space containing all the replay fields. The terms “image”, “replay image” and “image region” refer to areas of the replay field illuminated by light of the holographic reconstruction. In some embodiments, the “image” may comprise discrete spots which may be referred to as “image spots” or, for convenience only, “image pixels”.

The terms “encoding”, “writing” or “addressing” are used to describe the process of providing the plurality of pixels of the SLM with a respective plurality of control values which respectively determine the modulation level of each pixel. It may be said that the pixels of the SLM are configured to “display” a light modulation distribution in response to receiving the plurality of control values. Thus, the SLM may be said to “display” a hologram and the hologram may be considered an array of light modulation values or levels.

It has been found that a holographic reconstruction of acceptable quality can be formed from a “hologram” containing only phase information related to the Fourier transform of the original object. Such a holographic recording may be referred to as a phase-only hologram. Embodiments relate to a phase-only hologram but the present disclosure is equally applicable to amplitude-only holography.

The present disclosure is also equally applicable to forming a holographic reconstruction using amplitude and phase information related to the Fourier transform of the original object. In some embodiments, this is achieved by complex modulation using a so-called fully complex hologram which contains both amplitude and phase information related to the original object. Such a hologram may be referred to as a fully-complex hologram because the value (grey level) assigned to each pixel of the hologram has an amplitude and phase component. The value (grey level) assigned to each pixel may be represented as a complex number having both amplitude and phase components. In some embodiments, a fully-complex computer-generated hologram is calculated.

Reference may be made to the phase value, phase component, phase information or, simply, phase of pixels of the computer-generated hologram or the spatial light modulator as shorthand for “phase-delay”. That is, any phase value described is, in fact, a number (e.g. in the range 0 to 2π) which represents the amount of phase retardation provided by that pixel. For example, a pixel of the spatial light modulator described as having a phase value of π/2 will retard the phase of received light by π/2 radians. In some embodiments, each pixel of the spatial light modulator is operable in one of a plurality of possible modulation values (e.g. phase delay values). The term “grey level” may be used to refer to the plurality of available modulation levels. For example, the term “grey level” may be used for convenience to refer to the plurality of available phase levels in a phase-only modulator even though different phase levels do not provide different shades of grey. The term “grey level” may also be used for convenience to refer to the plurality of available complex modulation levels in a complex modulator.

The hologram therefore comprises an array of grey levels—that is, an array of light modulation values such as an array of phase-delay values or complex modulation values. The hologram is also considered a diffractive pattern because it is a pattern that causes diffraction when displayed on a spatial light modulator and illuminated with light having a wavelength comparable to, generally less than, the pixel pitch of the spatial light modulator. Reference is made herein to combining the hologram with other diffractive patterns such as diffractive patterns functioning as a lens or grating. For example, a diffractive pattern functioning as a grating may be combined with a hologram to translate the replay field on the replay plane or a diffractive pattern functioning as a lens may be combined with a hologram to focus the holographic reconstruction on a replay plane in the near field.

Although different embodiments and groups of embodiments may be disclosed separately in the detailed description which follows, any feature of any embodiment or group of embodiments may be combined with any other feature or combination of features of any embodiment or group of embodiments. That is, all possible combinations and permutations of features disclosed in the present disclosure are envisaged.

### BRIEF DESCRIPTION OF THE DRAWINGS

Specific embodiments are described by way of example only with reference to the following figures:

FIG. 1 is a schematic showing a reflective SLM producing a holographic reconstruction on a screen;

FIG. 2 shows an image for projection comprising eight image areas/components, V1 to V8, and cross-sections of the corresponding hologram channels, H1-H8;

FIG. 3 shows a hologram displayed on an LCOS that directs light into a plurality of discrete areas;

FIG. 4 shows a system, including a display device that displays a hologram that has been calculated as illustrated in FIGS. 2 and 3;

FIG. 5A shows a perspective view of a first example two-dimensional pupil expander comprising two replicators each comprising pairs of stacked surfaces;

FIG. 5B shows a perspective view of a first example two-dimensional pupil expander comprising two replicators each in the form of a solid waveguide;

FIG. 6 shows a perspective view of a light sensor optically coupled to the two-dimensional pupil expander comprising two replicators;

FIG. 7A shows a side perspective view of the arrangement of FIG. 6;

FIG. 7B shows a top down perspective view of the arrangement of FIG. 6; and

FIG. 8 shows a graph of intensity as measured by a light sensor.

The same reference numbers will be used throughout the drawings to refer to the same or like parts.

### DETAILED DESCRIPTION OF EMBODIMENTS

The present invention is not restricted to the embodiments described in the following but extends to the full scope of the appended claims. That is, the present invention may be embodied in different forms and should not be construed as limited to the described embodiments, which are set out for the purpose of illustration.

Terms of a singular form may include plural forms unless specified otherwise.

A structure described as being formed at an upper portion/lower portion of another structure or on/under the other structure should be construed as including a case where the structures contact each other and, moreover, a case where a third structure is disposed there between.

In describing a time relationship—for example, when the temporal order of events is described as “after”, “subsequent”, “next”, “before” or suchlike-the present disclosure should be taken to include continuous and non-continuous events unless otherwise specified. For example, the description should be taken to include a case which is not continuous unless wording such as “just”, “immediate” or “direct” is used.

Although the terms “first”, “second”, etc. may be used herein to describe various elements, these elements are not to be limited by these terms. These terms are only used to distinguish one element from another. For example, a first element could be termed a second element, and, similarly, a second element could be termed a first element, without departing from the scope of the appended claims.

Features of different embodiments may be partially or overall coupled to or combined with each other, and may be variously inter-operated with each other. Some embodiments may be carried out independently from each other, or may be carried out together in co-dependent relationship.

In the present disclosure, the term “substantially” when applied to a structural units of an apparatus may be interpreted as the technical feature of the structural units being produced within the technical tolerance of the method used to manufacture it.

### Conventional Optical Configuration for Holographic Projection

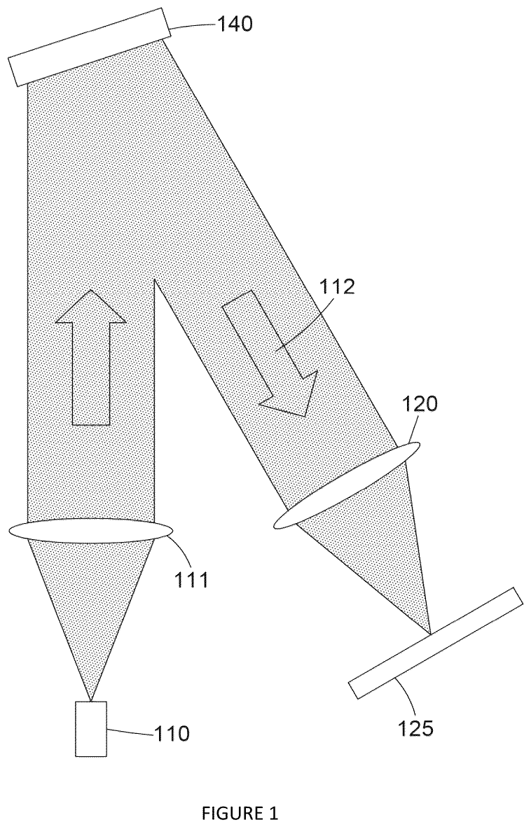

FIG. 1 shows an embodiment in which a computer-generated hologram is encoded on a single spatial light modulator. The computer-generated hologram is a Fourier transform of the object for reconstruction. It may therefore be said that the hologram is a Fourier domain or frequency domain or spectral domain representation of the object. In this embodiment, the spatial light modulator is a reflective liquid crystal on silicon, “LCOS”, device. The hologram is encoded on the spatial light modulator and a holographic reconstruction is formed at a replay field, for example, a light receiving surface such as a screen or diffuser.

A light source 110, for example a laser or laser diode, is disposed to illuminate the SLM 140 via a collimating lens 111. The collimating lens causes a generally planar wavefront of light to be incident on the SLM. In FIG. 1, the direction of the wavefront is off-normal (e.g. two or three degrees away from being truly orthogonal to the plane of the transparent layer). However, in other embodiments, the generally planar wavefront is provided at normal incidence and a beam splitter arrangement is used to separate the input and output optical paths. In the embodiment shown in FIG. 1, the arrangement is such that light from the light source is reflected off a mirrored rear surface of the SLM and interacts with a light-modulating layer to form an exit wavefront 112. The exit wavefront 112 is applied to optics including a Fourier transform lens 120, having its focus at a screen 125. More specifically, the Fourier transform lens 120 receives a beam of modulated light from the SLM 140 and performs a frequency-space transformation to produce a holographic reconstruction at the screen 125.

Notably, in this type of holography, each pixel of the hologram contributes to the whole reconstruction. There is not a one-to-one correlation between specific points (or image pixels) on the replay field and specific light-modulating elements (or hologram pixels). In other words, modulated light exiting the light-modulating layer is distributed across the replay field.

In these embodiments, the position of the holographic reconstruction in space is determined by the dioptric (focusing) power of the Fourier transform lens. In the embodiment shown in FIG. 1, the Fourier transform lens is a physical lens. That is, the Fourier transform lens is an optical Fourier transform lens and the Fourier transform is performed optically. Any lens can act as a Fourier transform lens but the performance of the lens will limit the accuracy of the Fourier transform it performs. The skilled person understands how to use a lens to perform an optical Fourier transform In some embodiments of the present disclosure, the lens of the viewer's eye performs the hologram to image transformation.

### Hologram Calculation

In some embodiments, the computer-generated hologram is a Fourier transform hologram, or simply a Fourier hologram or Fourier-based hologram, in which an image is reconstructed in the far field by utilising the Fourier transforming properties of a positive lens. The Fourier hologram is calculated by Fourier transforming the desired light field in the replay plane back to the lens plane. Computer-generated Fourier holograms may be calculated using Fourier transforms. Embodiments relate to Fourier holography and Gerchberg-Saxton type algorithms by way of example only. The present disclosure is equally applicable to Fresnel holography and Fresnel holograms which may be calculated by a similar method. In some embodiments, the hologram is a phase or phase-only hologram. However, the present disclosure is also applicable to holograms calculated by other techniques such as those based on point cloud methods.

In some embodiments, the hologram engine is arranged to exclude from the hologram calculation the contribution of light blocked by a limiting aperture of the display system. British patent application 2101666.2, filed 5 Feb. 2021 and incorporated herein by reference, discloses a first hologram calculation method in which eye-tracking and ray tracing are used to identify a sub-area of the display device for calculation of a point cloud hologram which eliminates ghost images. The sub-area of the display device corresponds with the aperture, of the present disclosure, and is used exclude light paths from the hologram calculation. British patent application 2112213.0, filed 26 Aug. 2021 and incorporated herein by reference, discloses a second method based on a modified Gerchberg-Saxton type algorithm which includes steps of light field cropping in accordance with pupils of the optical system during hologram calculation. The cropping of the light field corresponds with the determination of a limiting aperture of the present disclosure. British patent application 2118911.3, filed 23 Dec. 2021 and also incorporated herein by reference, discloses a third method of calculating a hologram which includes a step of determining a region of a so-called extended modulator formed by a hologram replicator. The region of the extended modulator is also an aperture in accordance with this disclosure. In some embodiments, there is provided a real-time engine arranged to receive image data and calculate holograms in real-time using the algorithm. In some embodiments, the image data is a video comprising a sequence of image frames. In other embodiments, the holograms are pre-calculated, stored in computer memory and recalled as needed for display on a SLM. That is, in some embodiments, there is provided a repository of predetermined holograms.

### Large Field of View Using Small Display Device

Broadly, the present disclosure relates to image projection. It relates to a method of image projection and an image projector which comprises a display device. The present disclosure also relates to a projection system comprising the image projector and a viewing system, in which the image projector projects or relays light from the display device to the viewing system. The present disclosure is equally applicable to a monocular and binocular viewing system. The viewing system may comprise a viewer's eye or eyes. The viewing system comprises an optical element having optical power (e.g., lens/es of the human eye) and a viewing plane (e.g., retina of the human eye/s). The projector may be referred to as a ‘light engine’. The display device and the image formed (or perceived) using the display device are spatially separated from one another. The image is formed, or perceived by a viewer, on a display plane. In some embodiments, the image is a virtual image and the display plane may be referred to as a virtual image plane. In other examples, the image is a real image formed by holographic reconstruction and the image is projected or relayed to the viewing plane. In these other examples, spatially modulated light of an intermediate holographic reconstruction formed either in free space or on a screen or other light receiving surface between the display device and the viewer, is propagated to the viewer. In both cases, an image is formed by illuminating a diffractive pattern (e.g., hologram or kinoform) displayed on the display device.

The display device comprises pixels. The pixels of the display may display a diffractive pattern or structure that diffracts light. The diffracted light may form an image at a plane spatially separated from the display device. In accordance with well-understood optics, the magnitude of the maximum diffraction angle is determined by the size of the pixels and other factors such as the wavelength of the light.

In embodiments, the display device is a spatial light modulator such as liquid crystal on silicon (“LCOS”) spatial light modulator (SLM). Light propagates over a range of diffraction angles (for example, from zero to the maximum diffractive angle) from the LCOS, towards a viewing entity/system such as a camera or an eye. In some embodiments, magnification techniques may be used to increase the range of available diffraction angles beyond the conventional maximum diffraction angle of an LCOS.

In some embodiments, the (light of a) hologram itself is propagated to the eyes. For example, spatially modulated light of the hologram (that has not yet been fully transformed to a holographic reconstruction, i.e. image)—that may be informally said to be “encoded” with/by the hologram—is propagated directly to the viewer's eyes. A real or virtual image may be perceived by the viewer. In these embodiments, there is no intermediate holographic reconstruction/image formed between the display device and the viewer. It is sometimes said that, in these embodiments, the lens of the eye performs a hologram-to-image conversion or transform. The projection system, or light engine, may be configured so that the viewer effectively looks directly at the display device.

Reference is made herein to a “light field” which is a “complex light field”. The term “light field” merely indicates a pattern of light having a finite size in at least two orthogonal spatial directions, e.g. x and y. The word “complex” is used herein merely to indicate that the light at each point in the light field may be defined by an amplitude value and a phase value, and may therefore be represented by a complex number or a pair of values. For the purpose of hologram calculation, the complex light field may be a two-dimensional array of complex numbers, wherein the complex numbers define the light intensity and phase at a plurality of discrete locations within the light field.

In accordance with the principles of well-understood optics, the range of angles of light propagating from a display device that can be viewed, by an eye or other viewing entity/system, varies with the distance between the display device and the viewing entity.

At a 1 metre viewing distance, for example, only a small range of angles from an LCOS can propagate through an eye's pupil to form an image at the retina for a given eye position. The range of angles of light rays that are propagated from the display device, which can successfully propagate through an eye's pupil to form an image at the retina for a given eye position, determines the portion of the image that is ‘visible’ to the viewer. In other words, not all parts of the image are visible from any one point on the viewing plane (e.g., any one eye position within a viewing window such as eye-box.)

In some embodiments, the image perceived by a viewer is a virtual image that appears upstream of the display device—that is, the viewer perceives the image as being further away from them than the display device. Conceptually, it may therefore be considered that the viewer is looking at a virtual image through an ‘display device-sized window’, which may be very small, for example 1 cm in diameter, at a relatively large distance, e.g., 1 metre. And the user will be viewing the display device-sized window via the pupil(s) of their eye(s), which can also be very small. Accordingly, the field of view becomes small and the specific angular range that can be seen depends heavily on the eye position, at any given time.

A pupil expander addresses the problem of how to increase the range of angles of light rays that are propagated from the display device that can successfully propagate through an eye's pupil to form an image. The display device is generally (in relative terms) small and the projection distance is (in relative terms) large. In some embodiments, the projection distance is at least one—such as, at least two-orders of magnitude greater than the diameter, or width, of the entrance pupil and/or aperture of the display device (i.e., size of the array of pixels).

Use of a pupil expander increases the viewing area (i.e., user's eye-box) laterally, thus enabling some movement of the eye/s to occur, whilst still enabling the user to see the image. As the skilled person will appreciate, in an imaging system, the viewing area (user's eye box) is the area in which a viewer's eyes can perceive the image. The present disclosure encompasses non-infinite virtual image distances—that is, near-field virtual images.

Conventionally, a two-dimensional pupil expander comprises one or more one-dimensional optical waveguides each formed using a pair of opposing reflective surfaces, in which the output light from a surface forms a viewing window or eye-box. Light received from the display device (e.g., spatially modulated light from a LCOS) is replicated by the or each waveguide so as to increase the field of view (or viewing area) in at least one dimension. In particular, the waveguide enlarges the viewing window due to the generation of extra rays or “replicas” by division of amplitude of the incident wavefront.

The display device may have an active or display area having a first dimension that may be less than 10 cms such as less than 5 cms or less than 2 cms. The propagation distance between the display device and viewing system may be greater than 1 m such as greater than 1.5 m or greater than 2 m. The optical propagation distance within the waveguide may be up to 2 m such as up to 1.5 m or up to 1 m. The method may be capable of receiving an image and determining a corresponding hologram of sufficient quality in less than 20 ms such as less than 15 ms or less than 10 ms.

In some embodiments—described only by way of example of a diffracted or holographic light field in accordance with this disclosure-a hologram is configured to route light into a plurality of channels, each channel corresponding to a different part (i.e. sub-area) of an image. The channels formed by the diffractive structure are referred to herein as “hologram channels” merely to reflect that they are channels of light encoded by the hologram with image information. It may be said that the light of each channel is in the hologram domain rather than the image or spatial domain. In some embodiments, the hologram is a Fourier or Fourier transform hologram and the hologram domain is therefore the Fourier or frequency domain. The hologram may equally be a Fresnel or Fresnel transform hologram. The hologram may also be a point cloud hologram. The hologram is described herein as routing light into a plurality of hologram channels to reflect that the image that can be reconstructed from the hologram has a finite size and can be arbitrarily divided into a plurality of image sub-areas, wherein each hologram channel would correspond to each image sub-area. Importantly, the hologram of this example is characterised by how it distributes the image content when illuminated. Specifically and uniquely, the hologram divides the image content by angle. That is, each point on the image is associated with a unique light ray angle in the spatially modulated light formed by the hologram when illuminated—at least, a unique pair of angles because the hologram is two-dimensional. For the avoidance of doubt, this hologram behaviour is not conventional. The spatially modulated light formed by this special type of hologram, when illuminated, may be divided into a plurality of hologram channels, wherein each hologram channel is defined by a range of light ray angles (in two-dimensions). It will be understood from the foregoing that any hologram channel (i.e. sub-range of light ray angles) that may be considered in the spatially modulated light will be associated with a respective part or sub-area of the image. That is, all the information needed to reconstruct that part or sub-area of the image is contained within a sub-range of angles of the spatially modulated light formed from the hologram of the image. When the spatially modulated light is observed as a whole, there is not necessarily any evidence of a plurality of discrete light channels.

Nevertheless, the hologram may still be identified. For example, if only a continuous part or sub-area of the spatially modulated light formed by the hologram is reconstructed, only a sub-area of the image should be visible. If a different, continuous part or sub-area of the spatially modulated light is reconstructed, a different sub-area of the image should be visible. A further identifying feature of this type of hologram is that the shape of the cross-sectional area of any hologram channel substantially corresponds to (i.e. is substantially the same as) the shape of the entrance pupil although the size may be different—at least, at the correct plane for which the hologram was calculated. Each light/hologram channel propagates from the hologram at a different angle or range of angles. Whilst these are example ways of characterising or identifying this type of hologram, other ways may be used. In summary, the hologram disclosed herein is characterised and identifiable by how the image content is distributed within light encoded by the hologram. Again, for the avoidance of any doubt, reference herein to a hologram configured to direct light or angularly-divide an image into a plurality of hologram channels is made by way of example only and the present disclosure is equally applicable to pupil expansion of any type of holographic light field or even any type of diffractive or diffracted light field.

The system can be provided in a compact and streamlined physical form. This enables the system to be suitable for a broad range of real-world applications, including those for which space is limited and real-estate value is high. For example, it may be implemented in a head-up display (HUD) such as a vehicle or automotive HUD.

In accordance with the present disclosure, pupil expansion is provided for diffracted or diffractive light, which may comprise diverging ray bundles. The diffracted light field may be defined by a “light cone”. Thus, the size of the diffracted light field (as defined on a two-dimensional plane) increases with propagation distance from the corresponding diffractive structure (i.e. display device). It can be said that the pupil expander/s replicate the hologram or form at least one replica of the hologram, to convey that the light delivered to the viewer is spatially modulated in accordance with a hologram.

In some embodiments, two one-dimensional waveguide pupil expanders are provided, each one-dimensional waveguide pupil expander being arranged to effectively increase the size of the exit pupil of the system by forming a plurality of replicas or copies of the exit pupil (or light of the exit pupil) of the spatial light modulator. The exit pupil may be understood to be the physical area from which light is output by the system. It may also be said that each waveguide pupil expander is arranged to expand the size of the exit pupil of the system. It may also be said that each waveguide pupil expander is arranged to expand/increase the size of the eye box within which a viewer's eye can be located, in order to see/receive light that is output by the system.

### Light Channelling

The hologram formed in accordance with some embodiments, angularly-divides the image content to provide a plurality of hologram channels which may have a cross-sectional shape defined by an aperture of the optical system. The hologram is calculated to provide this channelling of the diffracted light field. In some embodiments, this is achieved during hologram calculation by considering an aperture (virtual or real) of the optical system, as described above.

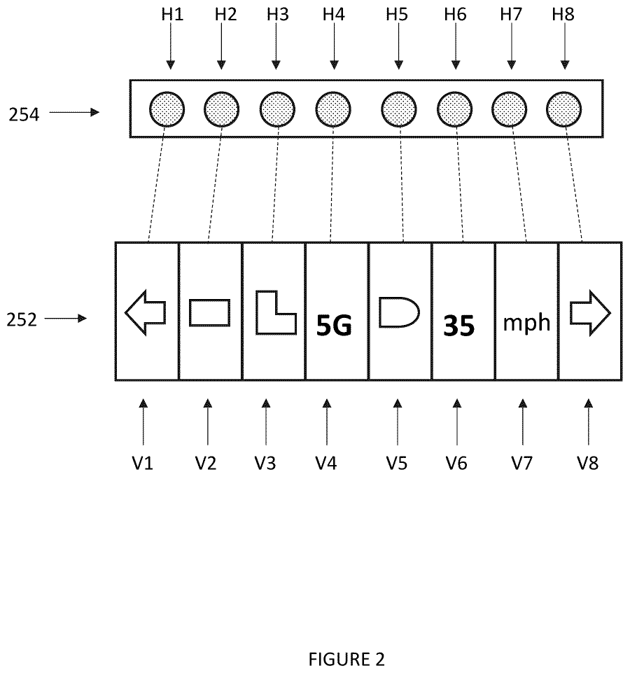

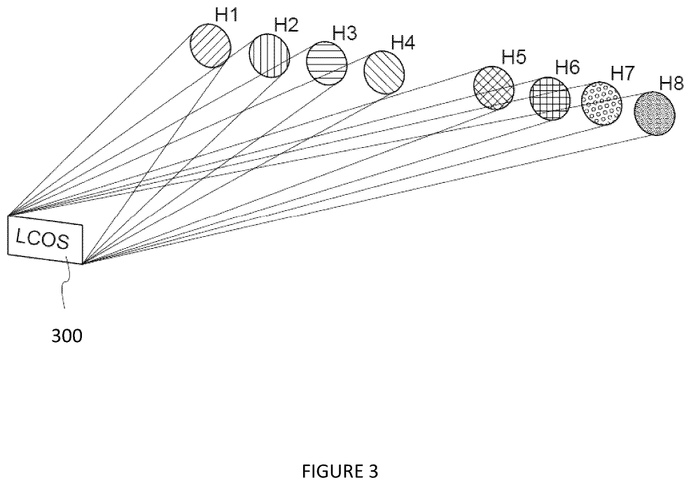

FIGS. 2 and 3 show an example of this type of hologram that may be used in conjunction with a pupil expander as disclosed herein. However, this example should not be regarded as limiting with respect to the present disclosure.

FIG. 2 shows an image 252 for projection comprising eight image areas/components, V1 to V8. FIG. 2 shows eight image components by way of example only and the image 252 may be divided into any number of components. FIG. 2 also shows an encoded light pattern 254 (i.e., hologram) that can reconstruct the image 252—e.g., when transformed by the lens of a suitable viewing system. The encoded light pattern 254 comprises first to eighth sub-holograms or components, H1 to H8, corresponding to the first to eighth image components/areas, V1 to V8. FIG. 2 further shows how a hologram may decompose the image content by angle. The hologram may therefore be characterised by the channelling of light that it performs. This is illustrated in FIG. 3. Specifically, the hologram in this example directs light into a plurality of discrete areas. The discrete areas are discs in the example shown but other shapes are envisaged. The size and shape of the optimum disc may, after propagation through the waveguide, be related to the size and shape of an aperture of the optical system such as the entrance pupil of the viewing system.

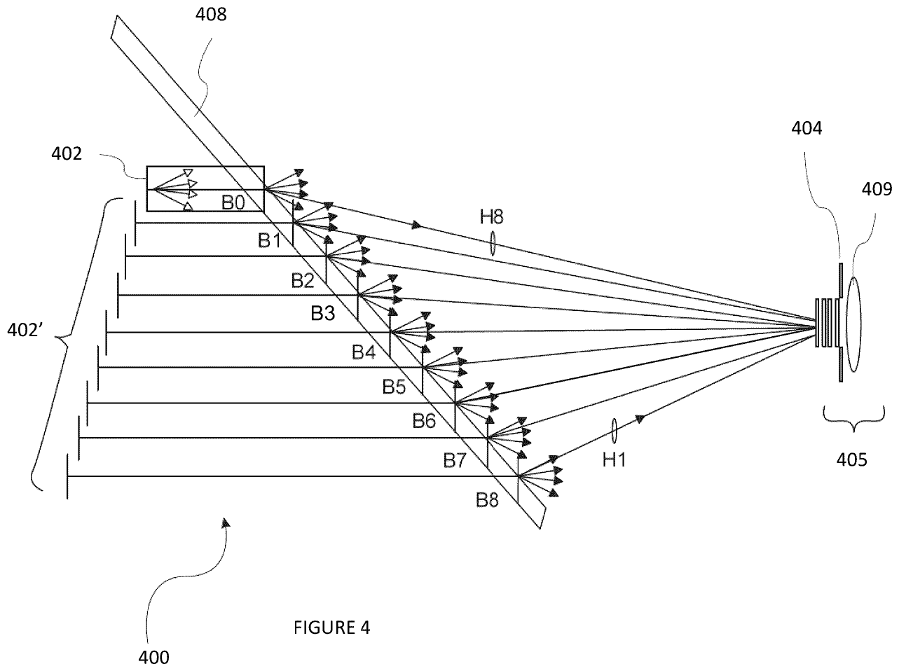

FIG. 4 shows a system 400, including a display device that displays a hologram that has been calculated as illustrated in FIGS. 2 and 3.

The system 400 comprises a display device, which in this arrangement comprises an LCOS 402. The LCOS 402 is arranged to display a modulation pattern (or ‘diffractive pattern’) comprising the hologram and to project light that has been holographically encoded towards an eye 405 that comprises a pupil that acts as an aperture 404, a lens 409, and a retina (not shown) that acts as a viewing plane. There is a light source (not shown) arranged to illuminate the LCOS 402. The lens 409 of the eye 405 performs a hologram-to-image transformation. The light source may be of any suitable type. For example, it may comprise a laser light source.

The viewing system 400 further comprises a waveguide 408 positioned between the LCOS 402 and the eye 405. The presence of the waveguide 408 enables all angular content from the LCOS 402 to be received by the eye, even at the relatively large projection distance shown. This is because the waveguide 508 acts as a pupil expander, in a manner that is well known and so is described only briefly herein.

In brief, the waveguide 408 shown in FIG. 4 comprises a substantially elongate formation. In this example, the waveguide 408 comprises an optical slab of refractive material, but other types of waveguide are also well known and may be used. The waveguide 408 is located so as to intersect the light cone (i.e., the diffracted light field) that is projected from the LCOS 402, for example at an oblique angle. In this example, the size, location, and position of the waveguide 408 are configured to ensure that light from each of the eight ray bundles, within the light cone, enters the waveguide 408. Light from the light cone enters the waveguide 408 via its first planar surface (located nearest the LCOS 402) and is guided at least partially along the length of the waveguide 408, before being emitted via its second planar surface, substantially opposite the first surface (located nearest the eye). As will be well understood, the second planar surface is partially reflective, partially transmissive. In other words, when each ray of light travels within the waveguide 408 from the first planar surface and hits the second planar surface, some of the light will be transmitted out of the waveguide 408 and some will be reflected by the second planar surface, back towards the first planar surface. The first planar surface is reflective, such that all light that hits it, from within the waveguide 408, will be reflected back towards the second planar surface. Therefore, some of the light may simply be refracted between the two planar surfaces of the waveguide 408 before being transmitted, whilst other light may be reflected, and thus may undergo one or more reflections, (or ‘bounces’) between the planar surfaces of the waveguide 408, before being transmitted.

FIG. 4 shows a total of nine “bounce” points, B0 to B8, along the length of the waveguide 408. Although light relating to all points of the image (V1-V8) as shown in FIG. 2 is transmitted out of the waveguide at each “bounce” from the second planar surface of the waveguide 408, only the light from one angular part of the image (e.g. light of one of V1 to V8) has a trajectory that enables it to reach the eye 405, from each respective “bounce” point, B0 to B8. Moreover, light from a different angular part of the image, V1 to V8, reaches the eye 405 from each respective “bounce” point. Therefore, each angular channel of encoded light reaches the eye only once, from the waveguide 408, in the example of FIG. 4.

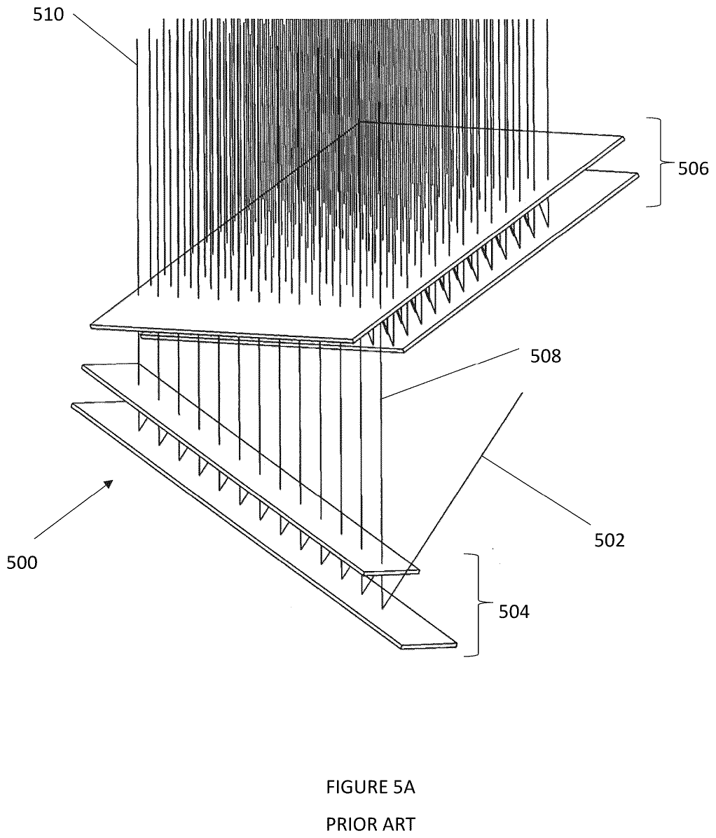

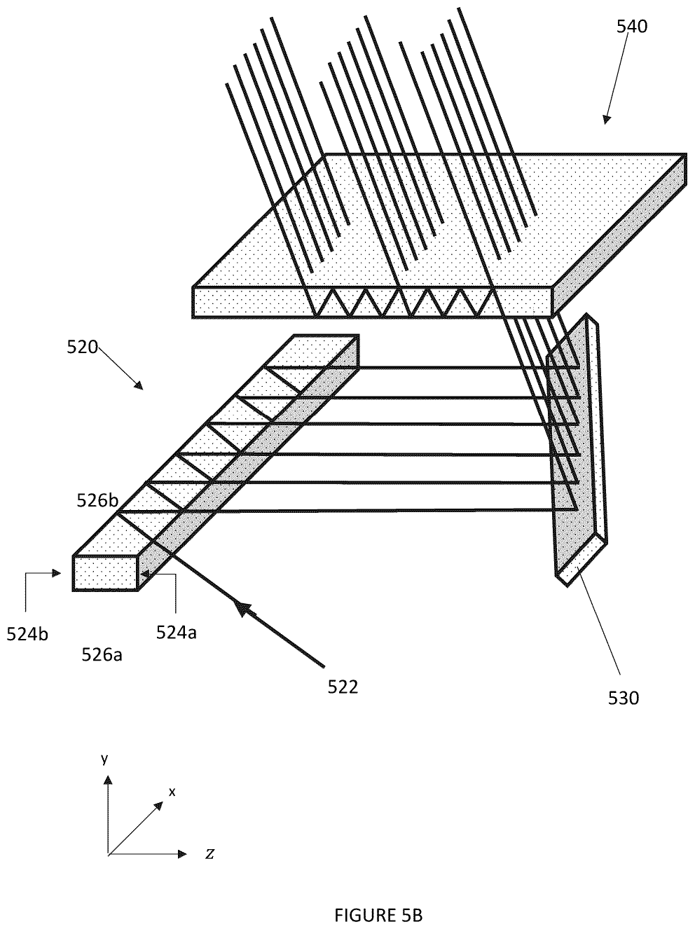

The waveguide 408 forms a plurality of replicas of the hologram, at the respective “bounce” points B1 to B8 along its length, corresponding to the direction of pupil expansion. As shown in FIG. 5, the plurality of replicas may be extrapolated back, in a straight line, to a corresponding plurality of replica or virtual display devices 402′. This process corresponds to the step of “unfolding” an optical path within the waveguide, so that a light ray of a replica is extrapolated back to a “virtual surface” without internal reflection within the waveguide. Thus, the light of the expanded exit pupil may be considered to originate from a virtual surface (also called an “extended modulator” herein) comprising the display device 402 and the replica display devices 402′.

Although virtual images, which require the eye to transform received modulated light in order to form a perceived image, have generally been discussed herein, the methods and arrangements described herein can be applied to real images.

### Two-Dimensional Pupil Expansion

Whilst the arrangement shown in FIG. 4 includes a single waveguide that provides pupil expansion in one dimension, pupil expansion can be provided in more than one dimension, for example in two dimensions. Moreover, whilst the example in FIG. 4 uses a hologram that has been calculated to create channels of light, each corresponding to a different portion of an image, the present disclosure and the systems that are described herebelow are not limited to such a hologram type.

FIG. 5A shows a perspective view of a system 500 comprising two replicators, 504, 506 arranged for expanding a light beam 502 in two dimensions.

In the system 500 of FIG. 5A, the first replicator 504 comprises a first pair of surfaces, stacked parallel to one another, and arranged to provide replication—or, pupil expansion—in a similar manner to the waveguide 408 of FIG. 4. The first pair of surfaces are similarly (in some cases, identically) sized and shaped to one another and are substantially elongate in one direction. The collimated light beam 502 is directed towards an input on the first replicator 504. Due to a process of internal reflection between the two surfaces, and partial transmission of light from each of a plurality of output points on one of the surfaces (the upper surface, as shown in FIG. 5A), which will be familiar to the skilled reader, light of the light beam 502 is replicated in a first direction, along the length of the first replicator 504. Thus, a first plurality of replica light beams 508 is emitted from the first replicator 504, towards the second replicator 506.

The second replicator 506 comprises a second pair of surfaces stacked parallel to one another, arranged to receive each of the collimated light beams of the first plurality of light beams 508 and further arranged to provide replication-or, pupil expansion-by expanding each of those light beams in a second direction, substantially orthogonal to the first direction. The first pair of surfaces are similarly (in some cases, identically) sized and shaped to one another and are substantially rectangular. The rectangular shape is implemented for the second replicator in order for it to have length along the first direction, in order to receive the first plurality of light beams 508, and to have length along the second, orthogonal direction, in order to provide replication in that second direction. Due to a process of internal reflection between the two surfaces, and partial transmission of light from each of a plurality of output points on one of the surfaces (the upper surface, as shown in FIG. 5A), light of each light beam within the first plurality of light beams 508 is replicated in the second direction. Thus, a second plurality of light beams 510 is emitted from the second replicator 506, wherein the second plurality of light beams 510 comprises replicas of the input light beam 502 along each of the first direction and the second direction. Thus, the second plurality of light beams 510 may be regarded as comprising a two-dimensional grid, or array, of replica light beams.

Thus, it can be said that the first and second replicators 504, 505 of FIG. 5A combine to provide a two-dimensional replicator (or, “two-dimensional pupil expander”). Thus, the replica light beams 510 may be emitted along an optical path to an expanded eye-box of a display system, such as a head-up display.

In the system of FIG. 5A, the first replicator 504 is a waveguide comprising a pair of elongate rectilinear reflective surfaces, stacked parallel to one another, and, similarly, the second replicator 504 is a waveguide comprising a pair of rectangular reflective surfaces, stacked parallel to one another. In other systems, the first replicator may be a solid elongate rectilinear waveguide and the second replicator may be a solid planar rectangular shaped waveguide, wherein each waveguide comprises an optically transparent solid material such as glass. In this case, the pair of parallel reflective surfaces are formed by a pair of opposed major sidewalls optionally comprising respective reflective and reflective-transmissive surface coatings, familiar to the skilled reader.

FIG. 5B shows a perspective view of a system 500 comprising two replicators, 520, 540 arranged for replicating a light beam 522 in two dimensions, in which the first replicator is a solid elongated waveguide 520 and the second replicator is a solid planar waveguide 540.

In the system of FIG. 5B, the first replicator/waveguide 520 is arranged so that its pair of elongate parallel reflective surfaces 524a, 524b are perpendicular to the plane of the second replicator/waveguide 540. Accordingly, the system comprises an optical coupler arranged to couple light from an output port of first replicator 520 into an input port of the second replicator 540. In the illustrated arrangement, the optical coupler is a planar/fold mirror 530 arranged to fold or turn the optical path of light to achieve the required optical coupling from the first replicator to the second replicator. As shown in FIG. 5B, the mirror 530 is arranged to receive light-comprising a one-dimensional array of replicas extending in the first dimension-from the output port/reflective-transmissive surface 524a of the first replicator/waveguide 520. The mirror 530 is tilted so as to redirect the received light onto an optical path to an input port in the (fully) reflective surface of second replicator 540 at an angle to provide waveguiding and replica formation, along its length in the second dimension. It will be appreciated that the mirror 530 is one example of an optical element that can redirect the light in the manner shown, and that one or more other elements may be used instead, to perform this task.

In the illustrated arrangement, the (partially) reflective-transmissive surface 524a of the first replicator 520 is adjacent the input port of the first replicator/waveguide 520 that receives input beam 522 at an angle to provide waveguiding and replica formation, along its length in the first dimension. Thus, the input port of first replicator/waveguide 520 is positioned at an input end thereof at the same surface as the reflective-transmissive surface 524a. The skilled reader will understand that the input port of the first replicator/waveguide 520 may be at any other suitable position.

Accordingly, the arrangement of FIG. 5B enables the first replicator 520 and the mirror 530 to be provided as part of a first relatively thin layer in a plane in the first and third dimensions (illustrated as an x-z plane). In particular, the size or “height” of a first planar layer—in which the first replicator 520 is located—in the second dimension (illustrated as the y dimension) is reduced. The mirror 530 is configured to direct the light away from a first layer/plane, in which the first replicator 520 is located (i.e. the “first planar layer”), and direct it towards a second layer/plane, located above and substantially parallel to the first layer/plane, in which the second replicator 540 is located (i.e. a “second planar layer”). Thus, the overall size or “height” of the system—comprising the first and second replicators 520, 540 and the mirror 530 located in the stacked first and second planar layers in the first and third dimensions (illustrated as an x-z plane)—in the second dimension (illustrated as the y dimension) is compact. The skilled reader will understand that many variations of the arrangement of FIG. 5B for implementing the present disclosure are possible and contemplated.

The image projector may be arranged to project a diverging or diffracted light field. In some embodiments, the light field is encoded with a hologram. In some embodiments, the diffracted light field comprises diverging ray bundles. In some embodiments, the image formed by the diffracted light field is a virtual image.

In some embodiments, the first pair of parallel/complementary surfaces are elongate or elongated surfaces, being relatively long along a first dimension and relatively short along a second dimension, for example being relatively short along each of two other dimensions, with each dimension being substantially orthogonal to each of the respective others. The process of reflection/transmission of the light between/from the first pair of parallel surfaces is arranged to cause the light to propagate within the first waveguide pupil expander, with the general direction of light propagation being in the direction along which the first waveguide pupil expander is relatively long (i.e., in its “elongate” direction).

There is disclosed herein a system that forms an image using diffracted light and provides an eye-box size and field of view suitable for real-world application—e.g. in the automotive industry by way of a head-up display. The diffracted light is light forming a holographic reconstruction of the image from a diffractive structure—e.g. hologram such as a Fourier or Fresnel hologram. The use diffraction and a diffractive structure necessitates a display device with a high density of very small pixels (e.g. 1 micrometer)—which, in practice, means a small display device (e.g. 1 cm). The inventors have addressed a problem of how to provide 2D pupil expansion with a diffracted light field e.g. diffracted light comprising diverging (not collimated) ray bundles.

In some embodiments, the display system comprises a display device—such as a pixelated display device, for example a spatial light modulator (SLM) or Liquid Crystal on Silicon (LCoS) SLM—which is arranged to provide or form the diffracted or diverging light. In such aspects, the aperture of the spatial light modulator (SLM) is a limiting aperture of the system. That is, the aperture of the spatial light modulator—more specifically, the size of the area delimiting the array of light modulating pixels comprised within the SLM—determines the size (e.g. spatial extent) of the light ray bundle that can exit the system. In accordance with this disclosure, it is stated that the exit pupil of the system is expanded to reflect that the exit pupil of the system (that is limited by the small display device having a pixel size for light diffraction) is made larger or bigger or greater in spatial extend by the use of at least one pupil expander.

The diffracted or diverging light field may be said to have “a light field size”, defined in a direction substantially orthogonal to a propagation direction of the light field. Because the light is diffracted/diverging, the light field size increases with propagation distance.

In some embodiments, the diffracted light field is spatially-modulated in accordance with a hologram. In other words, in such aspects, the diffractive light field comprises a “holographic light field”. The hologram may be displayed on a pixelated display device. The hologram may be a computer-generated hologram (CGH). It may be a Fourier hologram or a Fresnel hologram or a point-cloud hologram or any other suitable type of hologram. The hologram may, optionally, be calculated so as to form channels of hologram light, with each channel corresponding to a different respective portion of an image that is intended to be viewed (or perceived, if it is a virtual image) by the viewer. The pixelated display device may be configured to display a plurality of different holograms, in succession or in sequence. Each of the aspects and embodiments disclosed herein may be applied to the display of multiple holograms.

The output port of the first waveguide pupil expander may be coupled to an input port of a second waveguide pupil expander. The second waveguide pupil expander may be arranged to guide the diffracted light field—including some of, preferably most of, preferably all of, the replicas of the light field that are output by the first waveguide pupil expander—from its input port to a respective output port by internal reflection between a third pair of parallel surfaces of the second waveguide pupil expander.

The first waveguide pupil expander may be arranged to provide pupil expansion, or replication, in a first direction and the second waveguide pupil expander may be arranged to provide pupil expansion, or replication, in a second, different direction. The second direction may be substantially orthogonal to the first direction. The second waveguide pupil expander may be arranged to preserve the pupil expansion that the first waveguide pupil expander has provided in the first direction and to expand (or, replicate) some of, preferably most of, preferably all of, the replicas that it receives from the first waveguide pupil expander in the second, different direction. The second waveguide pupil expander may be arranged to receive the light field directly or indirectly from the first waveguide pupil expander. One or more other elements may be provided along the propagation path of the light field between the first and second waveguide pupil expanders.

The first waveguide pupil expander may be substantially elongated and the second waveguide pupil expander may be substantially planar. The elongated shape of the first waveguide pupil expander may be defined by a length along a first dimension. The planar, or rectangular, shape of the second waveguide pupil expander may be defined by a length along a first dimension and a width, or breadth, along a second dimension substantially orthogonal to the first dimension. A size, or length, of the first waveguide pupil expander along its first dimension make correspond to the length or width of the second waveguide pupil expander along its first or second dimension, respectively. A first surface of the pair of parallel surfaces of the second waveguide pupil expander, which comprises its input port, may be shaped, sized, and/or located so as to correspond to an area defined by the output port on the first surface of the pair of parallel surfaces on the first waveguide pupil expander, such that the second waveguide pupil expander is arranged to receive each of the replicas output by the first waveguide pupil expander.

The first and second waveguide pupil expander may collectively provide pupil expansion in a first direction and in a second direction perpendicular to the first direction, optionally, wherein a plane containing the first and second directions is substantially parallel to a plane of the second waveguide pupil expander. In other words, the first and second dimensions that respectively define the length and breadth of the second waveguide pupil expander may be parallel to the first and second directions, respectively, (or to the second and first directions, respectively) in which the waveguide pupil expanders provide pupil expansion. The combination of the first waveguide pupil expander and the second waveguide pupil expander may be generally referred to as being a “pupil expander”.

It may be said that the expansion/replication provided by the first and second waveguide expanders has the effect of expanding an exit pupil of the display system in each of two directions. An area defined by the expanded exit pupil may, in turn define an expanded eye-box area, from which the viewer can receive light of the input diffracted or diverging light field. The eye-box area may be said to be located on, or to define, a viewing plane.

The two directions in which the exit pupil is expanded may be coplanar with, or parallel to, the first and second directions in which the first and second waveguide pupil expanders provide replication/expansion. Alternatively, in arrangements that comprise other elements such as an optical combiner, for example the windscreen (or, windshield) of a vehicle, the exit pupil may be regarded as being an exit pupil from that other element, such as from the windscreen. In such arrangements, the exit pupil may be non-coplanar and non-parallel with the first and second directions in which the first and second waveguide pupil expanders provide replication/expansion. For example, the exit pupil may be substantially perpendicular to the first and second directions in which the first and second waveguide pupil expanders provide replication/expansion.

The viewing plane, and/or the eye-box area, may be non-coplanar or non-parallel to the first and second directions in which the first and second waveguide pupil expanders provide replication/expansion. For example, a viewing plane may be substantially perpendicular to the first and second directions in which the first and second waveguide pupil expanders provide replication/expansion.

In order to provide suitable launch conditions to achieve internal reflection within the first and second waveguide pupil expanders, an elongate dimension of the first waveguide pupil expander may be tilted relative to the first and second dimensions of the second waveguide pupil expander.

### Combiner Shape Compensation

An advantage of projecting a hologram to the eye-box is that optical compensation can be encoded in the hologram (see, for example, European patent 2936252 incorporated herein by herein). The present disclosure is compatible with holograms that compensate for the complex curvature of an optical combiner used as part of the projection system. In some embodiments, the optical combiner is the windscreen of a vehicle. Full details of this approach are provided in European patent 2936252 and are not repeated here because the detailed features of those systems and methods are not essential to the new teaching of this disclosure herein and are merely exemplary of configurations that benefit from the teachings of the present disclosure.

### Control Device

The present disclosure is also compatible with optical configurations that include a control device (e.g. light shuttering device) to control the delivery of light from a light channelling hologram to the viewer. The holographic projector may further comprise a control device arranged to control the delivery of angular channels to the eye-box position. British patent application 2108456.1, filed 14 Jun. 2021 and incorporated herein by reference, discloses the at least one waveguide pupil expander and control device. The reader will understand from at least this prior disclosure that the optical configuration of the control device is fundamentally based upon the eye-box position of the user and is compatible with any hologram calculation method that achieves the light channeling described herein. It may be said that the control device is a light shuttering or aperturing device. The light shuttering device may comprise a 1D array of apertures or windows, wherein each aperture or window independently switchable between a light transmissive and a light non-transmissive state in order to control the deliver of hologram light channels, and their replicas, to the eye-box. Each aperture or window may comprise a plurality of liquid crystal cells or pixels.

### Detecting Defects

The term “brightness” is used herein as shorthand for “intensity” or “illuminance” to represent the magnitude or amplitude of a light wave as measured by a light detector. The term “input wavefront” is used herein as shorthand for the wavefront of light (from a spatial light modulator) that is encoded with the picture, and replicated by at least one replicator such as waveguide. In some embodiments, the “input wavefront” is a “holographic wavefront” meaning a wavefront encoded (e.g. spatially modulated) with a hologram of the picture rather than the picture itself. In some embodiments, an extended wavefront is formed by replicating the input wavefront in one direction or two perpendicular directions. The term “fault” is used herein as an example of a defect, imperfect, damage or abnormality that may be detectable in accordance with the present disclosure.

A defect in a waveguide or waveguides can affect (e.g. increase or decrease) the amount of light exiting a holographic projection system. If the waveguide or waveguides, e.g. the optical coating of said waveguide(s), become damaged (e.g. scratched) or degraded, the amount of light being emitted by the system may locally change. This may be undesirable.

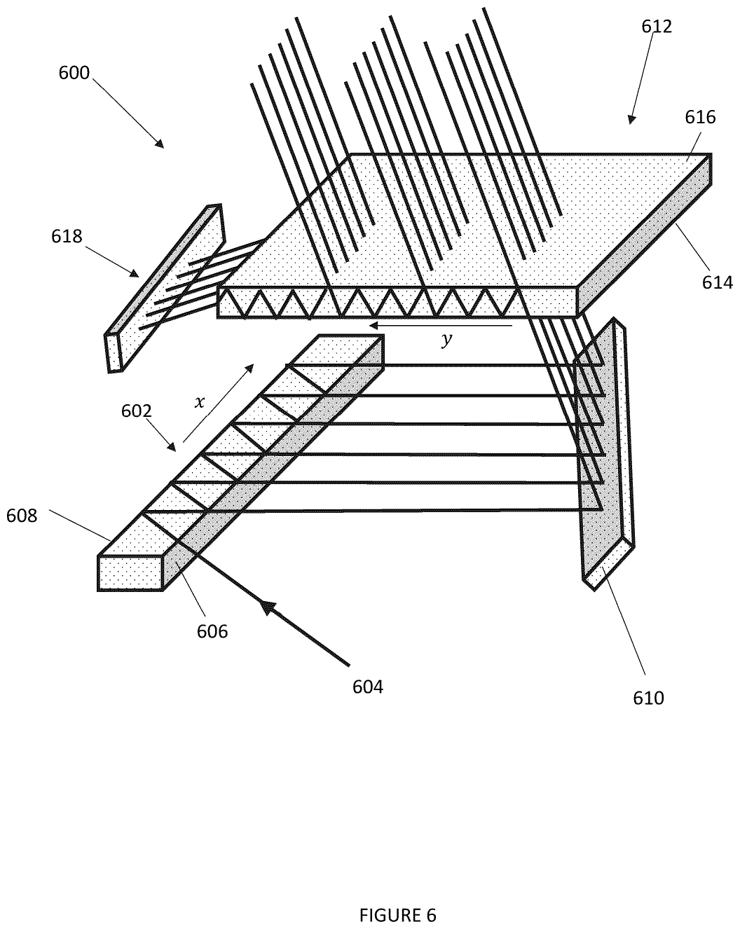

FIG. 6 depicts a light sensor optically coupled to the two-dimensional pupil expander comprising two replicators as described above with reference to FIG. 5B. In this embodiment, a first waveguide 602 receives a first wavefront 604. The first wavefront 604 corresponds to the holographic image to be seen by a viewer. The first waveguide 602 replicates the first wavefront 604 along the x axis. The first waveguide 602 also provides waveguiding of the first wavefront 604 by internal reflection between a first surface 606 of the first waveguide 602 and a second surface 608 of the first waveguide 602 positioned opposite to the first surface 606. The first surface 606 comprises a first input port where the first wavefront 604 is received. The first surface 606 is partially transmissive reflective and the second surface 608 is reflective. The first input port 606 may be optically transparent or partially transmissive reflective. The first waveguide 602 outputs a plurality of intermediate wavefronts from first surface 606 towards a mirror 610 which directs the intermediate wavefront towards a second waveguide 612. Each intermediate wavefront comprises a replica of the first wavefront 604.

The second waveguide 612 replicates the received plurality of intermediate wavefronts along the y axis. The y axis is perpendicular to the x axis. As the skilled person will appreciate, the y axis in FIG. 6 is equivalent to the z axis in FIG. 5B. The second waveguide 612 also provides waveguiding of the intermediate wavefront by internal reflection between a third surface 614 and a fourth surface 616 positioned opposite to the third surface 614. The third surface 614 comprises a second input port where the plurality of intermediate wavefronts are received. The fourth surface 616 is partially transmissive reflective and the third surface 614 is reflective. The second input port may be optically transparent or partially transmissive reflective. The second waveguide 612 outputs a plurality of second wavefronts/wavefront replicas from fourth surface 616 towards an eye-box so that a viewer in the eye-box receives one or more of the plurality of wavefront replicas. The second wavefront comprises a plurality of replicas of the intermediate wavefront/first wavefront 604. The replication/waveguiding by the first and second waveguides 602, 612 is the same process as described above.

A detector strip 618 is optically coupled to the second waveguide 612 such that the detector strip 618 can measure the intensity of a residual portion of the wavefront after waveguiding and/or replication along the y axis. The residual portion(s) of the wavefront propagate from the second input port adjacent one edge of the second waveguide 612 in the propagation direction along the y axis and out through an opposite edge of the second waveguide 612 to the detector strip 618. In this embodiment, the detector strip 618 comprises an array of sensors (such as photodiodes) each of which is positioned to measure the intensity of a respective residual portion of a replica of the first wavefront comprised in the intermediate wavefront. In this embodiment, the detector strip 618 comprises an array of sensors arranged along the x axis. The array of sensors may be spatially separated from each other along the x axis. The array of sensors may be spatially separated and equidistant from each other along the x axis.

A defect in the second waveguide can be determined based on the measured intensity of the or each residual portion. For example, a defect may be determined based on a comparison of the measured intensity with a threshold intensity, in particular if the measured intensity is less than the threshold intensity. One method of determining the occurrence of a defect comprises comparing the measured intensity of each of the replicas of the first wavefront 604 with a respective expected intensity of each of the replicas of the first wavefront 604. When there is a defect in the second waveguide 612, the measured intensity of one or more replicas of the first wavefront 604 (the replicas having propagation paths that intercept the fault) may be lower than their respective expected intensity. Moreover, the location of the one or more sensor/detector that measured the lower-than-expected intensity may provide an indication of the location of the fault within the second waveguide 612. The expected intensity can be determined by empirical measurements previously obtained or calculated based on the light propagation properties of the second waveguide 612 and propagation path of the intermediate wavefront.

Additionally/alternatively, determining a defect can comprise comparing the intensity of each of the residual portions of the replicas of the first wavefront 604 with the intensity of one or more adjacent/neighbouring residual portions. If the measured intensity of a particular residual portion is lower than one or both of its neighbouring replicas, then this may indicate the presence of a defect. Again, the position of the sensor that measured the low intensity replica may provide an indication of where the fault is located within the second waveguide 612.

In other embodiments, an additional detector (not shown) may be optically coupled to the first waveguide 602 in order to measure the intensity of a residual portion of the first wavefront 604 after waveguiding and/or replication along the x axis. The additional detector may comprise one or more light sensors/detectors and may be optically coupled to an edge of the first waveguide 602 at the opposite end (in the x direction) to the input port thereof. A defect in the first waveguide 602 may be determined by comparing the detected intensity with an expected intensity as described above. As the skilled person will appreciate, defects in a system comprising only a one dimensional replicator, such as first waveguide 602, may therefore be detected in accordance with the present disclosure.

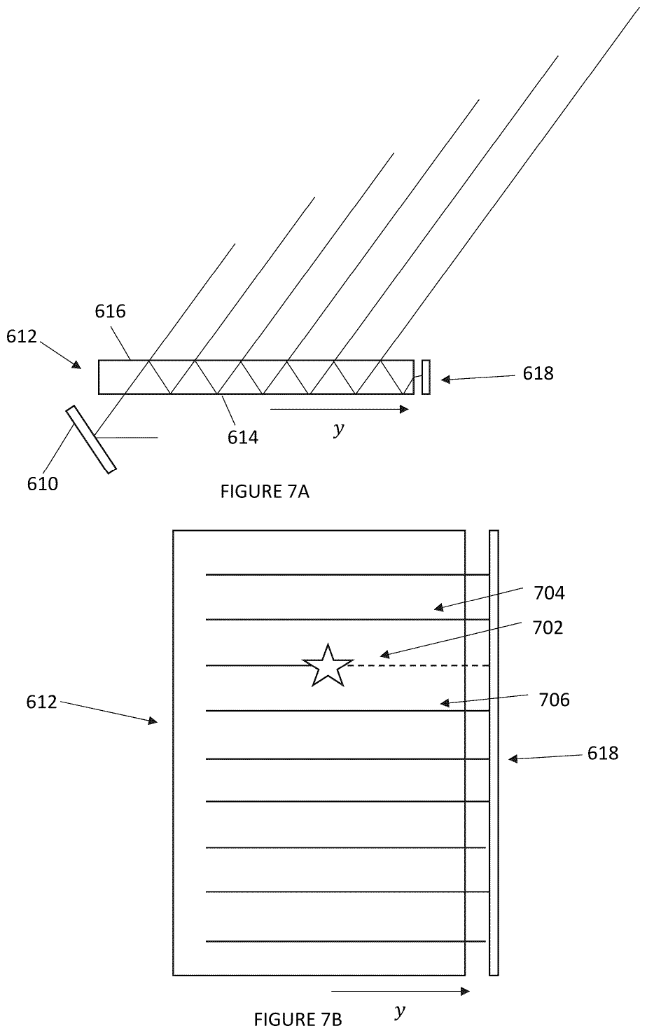

FIG. 7A depicts a side perspective view of the arrangement of FIG. 6. FIG. 7A shows a path that a particular replica of the first wavefront 604 (comprised in the intermediate wavefront) received from the first waveguide 602 travels through in the second waveguide 612. The particular replica of the first wavefront 604 is reflected between the third and fourth surfaces 614, 616 thereby producing a plurality of further replicas, along the y axis, of that particular replica of the first wavefront 604. A residual portion of the replica of the first wavefront will exit the second waveguide 612 from the fifth surface of second waveguide 612. This residual portion of the particular replica can be used to detect any faults in the second waveguide 612 along the propagation path of the particular replica.

FIG. 7B depicts a top down perspective view of the arrangement of FIG. 6. FIG. 7B shows the path that each of the replicas of the first wavefront 604 (comprised in the intermediate wavefront) received from the first waveguide 602 travels through in the second waveguide 612. In particular, a residual portion of each of the replicas of the first wavefront exits the second wavefront from the fifth surface/edge of the second waveguide 612. The residual portion of each of the replicas of the first wavefront 604 is received on a respective sensor on the detector strip 618. In this way, the intensity of the residual portion of each of the replicas of the first wavefront 604 can be measured. The intensity of the residual portions can be indicative of the intensity of each of replicas of the first wavefront 604. By comparing the measured intensity with a respective expected intensity, the presence of a defect can be determined. Further, the nature of the defect may be determined. For example, the second waveguide 612 comprises a defect positioned in the propagation path of replica 702. Such a defect typically prevents the replica 702 from being waveguided further in the propagation direction and leads to loss of light. For example, a scratch or similar defect in a reflective coating at one of the third and fourth surface 614, 616 may cause scattering and/or loss of some of the light of the replica 702 at the defect. As such, the measured intensity of replica 702 will be lower than its adjacent replicas 704, 706 and/or an expected intensity, i.e. the intensity of replica 702 if the defect is not present.

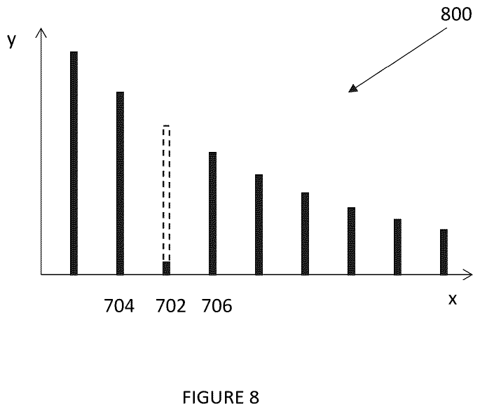

FIG. 8 depicts a graph 800 showing the intensity of each of the replicas of the first wavefront as measured by the detector strip 618. The graph 800 has an x-axis representing the position on the detector strip 618, i.e. the location of each of sensors relative to the second waveguide 612. The graph 800 has a y-axis representing intensity, i.e. the intensity of the residual portion of each of the replicas as measured by the detector strip 618. As shown in graph 800, the intensity of the residual portion of replica 802 has a significantly lower intensity than the expected intensity shown by dashed lines. Moreover, the intensity of the residual portion of replica 802 is also significantly lower than the residual portions of neighbouring replicas 704, 706. Furthermore, as shown in graph 800 the intensity of the replicas lowers as the distance relative to the input port, e.g. the first input port of the first waveguide 602, increases. An expected decrease in intensity can be calculated for the system and thus may also be taken into account when determining an expected intensity.

### Additional Features

The methods and processes described herein may be embodied on a computer-readable medium. The term “computer-readable medium” includes a medium arranged to store data temporarily or permanently such as random-access memory (RAM), read-only memory (ROM), buffer memory, flash memory, and cache memory. The term “computer-readable medium” shall also be taken to include any medium, or combination of multiple media, that is capable of storing instructions for execution by a machine such that the instructions, when executed by one or more processors, cause the machine to perform any one or more of the methodologies described herein, in whole or in part.

The term “computer-readable medium” also encompasses cloud-based storage systems. The term “computer-readable medium” includes, but is not limited to, one or more tangible and non-transitory data repositories (e.g., data volumes) in the example form of a solid-state memory chip, an optical disc, a magnetic disc, or any suitable combination thereof. In some example embodiments, the instructions for execution may be communicated by a carrier medium. Examples of such a carrier medium include a transient medium (e.g., a propagating signal that communicates instructions).

It will be apparent to those skilled in the art that various modifications and variations can be made without departing from the scope of the appended claims. The present disclosure covers all modifications and variations within the scope of the appended claims and their equivalents.

What is claimed is:

1. A light engine configured to detect a defect, wherein the light engine comprises:
a waveguide, wherein the waveguide comprises (i) a first surface that is partially transmissive-reflective, and (ii) a second surface opposite to the first surface;
wherein the waveguide is configured to: (i) receive, on an input port, a wavefront, and (ii) provide waveguiding of the input wavefront by internal reflection between the first and second surfaces thereby replicating the wavefront along a replication direction; and
a light detector positioned to measure an intensity of a residual portion of the wavefront after waveguiding is provided by the waveguide.

2. The light engine of claim 1, further comprising a processor communicatively coupled to the light detector, wherein the processor is configured to determine the defect based on the measured intensity.

3. The light engine of claim 2, wherein the processor is configured to determine the defect based on a comparison between the measured intensity and one of (i) a threshold intensity or (ii) an expected intensity.

4. The light engine of claim 1, further comprising:
a further waveguide, wherein the further waveguide comprises: (i) a further first surface that is partially transmissive-reflective, and (ii) a further second surface positioned opposite to the further first surface; and
wherein the further waveguide is configured to: (i) receive, on a further input port on the further first surface, a further input wavefront, (ii) provide waveguiding of the further input wavefront by internal reflection between the further first and second surfaces, thereby replicating the further input wavefront along a further replication direction, where the further replication direction is perpendicular to the replication direction, and (iii) output, from the further first surface or the further second surface, the input wavefront, wherein the input wavefront comprises one or more replicas of the further input wavefront.

5. The light engine of claim 4, wherein the light detector is configured to measure the intensity of the residual portion of the input wavefront after waveguiding is provided by the waveguide by measuring a intensity of a residual portion of each of the replicas of the further input wavefront after waveguiding is provided by the waveguide.

6. The light engine of claim 4, further comprising a processor, wherein the processor is configured to determine the defect based on the measured intensity wherein the processor is configured to determine the defect based on at least one of (i) a measured intensity of a residual portion of one of the replicas of the further input wavefront or (ii) a comparison of a measured intensity of one of the replicas of the further input wavefront and a residual portion of an adjacent replica of the further input wavefront.

7. The light engine of claim 4, wherein the further waveguide has an elongated shape and the waveguide has a planar shape.

8. The light engine of claim 4, further comprising a further light detector positioned to measure a further intensity of a residual portion of the further input wavefront after waveguiding is provided by the further waveguide.

9. The light engine of claim 4, wherein the light detector comprises an array of detectors.

10. The light engine of claim 9, wherein each detector of the array of detectors is positioned to receive a respective residual portion of the further input wavefront.

11. The light engine of claim 9, further comprising a processor, wherein the processor is configured to determine a location of the defect based on which detector in the array of detectors detected the defect.

12. The light engine of claim 1, further comprising:
a control device, wherein the control device comprises at least one aperture arranged to be switchable between a light transmissive state and a light non-transmissive state, wherein the light engine is arranged such that the input wavefront passes through the at least one aperture prior to being received at the input port.

13. The light engine of claim 12, further comprising a processor, wherein the processor is configured to determine the defect based on the whether the at least one aperture is in the light transmissive state or the light non-transmissive state.

14. The light engine of claim 1, wherein:
the waveguide further comprises a third surface extending from the first surface to the second surface; and
the light detector is optically coupled to the third surface.

15. A method for determining a defect in a light engine, the method comprising:
receiving, on an input port on a first surface of a waveguide, an input wavefront, the first surface being partially transmissive-reflective;
providing waveguiding of the input wavefront by internal reflection of the input wavefront between the first surface and a second surface of the waveguide positioned opposite to the first surface; and
measuring, by a light detector, an intensity of a residual portion of the input wavefront after waveguiding has been provided by the waveguide.

16. The method of claim 15, further comprising:
determining, by a processor communicatively coupled to the light detector, the defect based on the measured intensity by comparing the measured intensity with a threshold intensity.

17. The method of claim 15, further comprising:
receiving, on a further input port on a further first surface of a further waveguide, a further input wavefront, the further first surface being partially transmissive-reflective;
providing waveguiding of the further input wavefront by internal reflection of the further input wavefront between the further first surface and a further second surface of the further waveguide positioned opposite to the further first surface; and
outputting the input wavefront from the further second surface towards the first surface.

18. The method of claim 17, further comprising:
measuring, by a further light detector, a further intensity of a residual portion of the further input wavefront after waveguiding is provided by the further waveguide, wherein determining the defect is based on the measured further intensity of the further input wavefront.

19. The method of claim 17, wherein determining the defect comprises at least one of:
comparing the measured intensity with an expected intensity; or
comparing a measured intensity of a residual portion of at least one replica of the further input wavefront with a measured intensity of a residual portion of an adjacent replica of the further input wavefront.

20. The method of claim 17, wherein the light detector comprises an array of detectors, wherein individual detectors in the array of detectors are positioned to receive a respective replica of the further input wavefront, and wherein the method further comprises:
determining, by a processor, a location of the defect based on the array of detectors.
